(19) United States
(12) Patent Application Publication
(10) Pub. No.: US 2026/0158780 A1
(43) Pub. Date: Jun. 11, 2026

(54) LIQUID EJECTING APPARATUS AND DRIVING METHOD

(71) Applicant: SEIKO EPSON CORPORATION, Tokyo (JP)

(72) Inventors: Toshiyuki YAMAGATA, SHIOJIRI-SHI (JP); Tomohiro MATSUBAYASHI, MATSUMOTO-SHI (JP)

(21) Appl. No.: 19/406,134

(22) Filed: Dec. 2, 2025

(30) Foreign Application Priority Data
Dec. 5, 2024 (JP) 2024-211969

(51) Int. Cl. B41J 2/045

(52) U.S. Cl. CPC B41J 2/0459; B41J 2/04516; B41J 2/0455; B41J 2/04573; B41J 2/04581; B41J 2/04588

(57) ABSTRACT

A liquid ejecting apparatus includes an ejecting section that includes nozzle, a pressure chamber, and a drive element that is configure to generate pressure fluctuation in the liquid in the pressure chamber in response to a supplied drive signal. The drive signal includes a first ejection pulse for ejecting the liquid from the nozzle. The first ejection pulse includes a first depressurized-potential change component to reduce pressure of the liquid in the pressure chamber, and a first pressurized-potential change component to increase the pressure of the liquid in the pressure chamber to protrude a liquid surface from the nozzle after the first depressurized-potential change component. A potential change range of the first depressurized-potential change component is 40% or more of a potential change range of the first pressurized-potential change component. A potential change rate of the first depressurized-potential change component is 1 V/μsec or more and 2 V/μsec or less.

The present application is based on, and claims priority from JP Application Serial Number 2024-211969, filed December 5, 2024, the disclosure of which is hereby incorporated by reference herein in its entirety.

### BACKGROUND

### 1. Technical Field

The present disclosure relates to a liquid ejecting apparatus and a driving method.

### 2. Related Art

In general, a liquid ejecting apparatus which forms an image on a medium, such as recording paper, has been widely used. The liquid ejecting apparatus includes an ejecting section which includes a nozzle which ejects liquid, such as ink, a pressure chamber which communicates with the nozzle, and a drive element which is driven so as to generate pressure fluctuation in the liquid in the pressure chamber in accordance with a supplied drive signal.

Such an apparatus is disclosed in JP-A-2017-95814.

However, in the liquid ejecting apparatus, fine liquid droplets in a mist state, so-called mist, may be generated due to tailing of the ejected liquid. When the mist is generated, the mist adheres to a periphery of the nozzle, which may cause deterioration of ejection performance and ejection failure. Due to the deterioration of the ejection performance and the ejection failure, the quality of an image formed on the medium deteriorates.

### SUMMARY

According to an aspect of the present disclosure, a liquid ejecting apparatus includes ejecting sections each of which includes nozzles which eject liquid, a pressure chamber which communicates with the nozzles, and a drive element which is driven so as to generate pressure fluctuation in the liquid in the pressure chamber in response to a supplied drive signal, and a drive signal generation circuit that generates the drive signal. The drive signal includes a first ejection pulse for ejecting the liquid from the nozzles. The first ejection pulse includes a first depressurized-potential change component that drives the drive element so that pressure of the liquid in the pressure chamber is reduced, and a first pressurized-potential change component that drives the drive element so that the pressure of the liquid in the pressure chamber increases such that liquid surfaces protrude from the nozzles after the first depressurized-potential change component. A potential change range of the first depressurized-potential change component is 40% or more of a potential change range of the first pressurized-potential change component. A potential change rate of the first depressurized-potential change component is 1 V/μsec or more and2 V/μsec or less.

According to another aspect of the present disclosure, a driving method drives a liquid ejecting apparatus including ejecting sections each of which includes nozzles which eject liquid, a pressure chamber which communicates with the nozzles, and a drive element which is driven so as to generate pressure fluctuation in the liquid in the pressure chamber in response to a supplied drive signal, and a drive signal generation circuit that generates the drive signal. The drive signal includes a first ejection pulse for ejecting the liquid from the nozzles. The first ejection pulse includes a first depressurized-potential change component that drives the drive element so that pressure of the liquid in the pressure chamber is reduced, and a first pressurized-potential change component that drives the drive element so that pressure of the liquid in the pressure chamber increases such that liquid surfaces protrude from the nozzles after the first depressurized-potential change component. A potential change range of the first depressurized-potential change component is 40% or more of a potential change range of the first pressurized-potential change component. A potential change rate of the first depressurized-potential change component is 1 V/μsec or more and 2 V/μsec or less. The driving method executes supplying the first depressurized-potential change component to the drive element of the ejecting section, and supplying the first pressurized-potential change component to the drive element of the ejecting section.

### BRIEF DESCRIPTION OF THE DRAWINGS

FIG. 1 is a diagram schematically illustrating an example of a configuration of a liquid ejecting apparatus according to a first embodiment.

FIG. 2 is a diagram illustrating an electrical configuration of the liquid ejecting apparatus according to the first embodiment.

FIG. 3 is a cross-sectional view illustrating an example of a head chip.

FIG. 4 is a diagram describing a switching circuit.

FIG. 5 is a graph for explaining the reason that mist is generated in a small dot ejection pulse according to a comparative example.

FIG. 6 is a diagram for explaining a drive signal for generating a supply signal to be supplied to the head chip.

FIG. 7 is a graph for explaining individual elements of a small dot ejection pulse.

FIG. 8 is a flowchart of an operation of the liquid ejecting apparatus according to the first embodiment.

FIG. 9 is a graph for explaining a small dot ejection pulse according to a first modification.

FIG. 10 is a graph for explaining a small dot ejection pulse according to a second modification.

FIG. 11 is a diagram for explaining a large dot ejection pulse according to a third modification.

FIG. 12 is a diagram for explaining a large dot ejection pulse according to a fourth modification.

FIG. 13 is a diagram for explaining a large dot ejection pulse according to a fifth modification.

### DESCRIPTION OF EMBODIMENTS

Hereinafter, embodiments of the present disclosure will be described with reference to the accompanying drawings. However, in the individual drawings, dimensions and scales of individual sections are appropriately different from actual sections. In addition, since the embodiments described below are suitable specific examples of the present disclosure, various technically preferable limitations are added, and the scope of the present disclosure is not limited to these embodiments unless otherwise stated in the following description to particularly limit the present disclosure.

The following description will be made by using an X-axis, a Y-axis, and a Z-axis that intersect each other as appropriate. In the following, a direction along the X-axis is an X1 direction, and a direction opposite to the X1 direction is an X2 direction. In the same manner, directions opposite to each other along the Y-axis are a Y1 direction and a Y2 direction. Mutually opposite directions along the Z-axis are a Z1 direction and a Z2 direction.

Here, typically, the Z-axis is a vertical axis, and the Z2 direction corresponds to a downward direction in the vertical direction. Meanwhile, the Z-axis may not be the vertical axis. The X-axis, the Y-axis, and the Z-axis are typically orthogonal to each other, but are not limited to this, and only intersect each other at, for example, an angle within a range of, for example, 80° or more and 100° or less.

### A: First Embodiment

### A1: Overall Configuration of Liquid Ejecting Apparatus

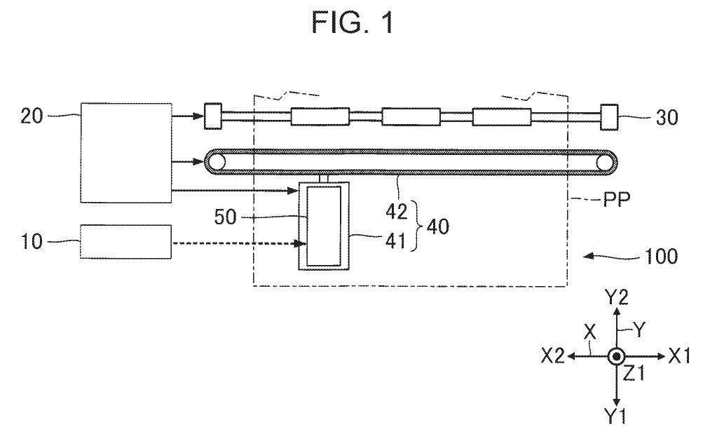

FIG. 1 is a diagram schematically illustrating an example of a configuration of a liquid ejecting apparatus 100 according to a first embodiment. The liquid ejecting apparatus 100 is an ink jet printing apparatus that ejects ink, which is an example of liquid, onto a medium PP in a form of a droplet. The medium PP is, for example, printing paper. The medium PP is not limited to the printing paper, and may be, for example, a printing target of any material, such as a resin film or cloth.

As illustrated in FIG. 1, the liquid ejecting apparatus 100 includes a liquid container 10, a control unit 20, a transport mechanism 30, a moving mechanism 40, and a liquid ejecting head 50.

The liquid container 10 stores ink. Specific aspects of the liquid container 10 include, for example, a cartridge that is attachable to and detachable from the liquid ejecting apparatus 100, a bag-shaped ink pack formed of a flexible film, and an ink tank that can be refilled with the ink. An arbitrary type of ink is stored in the liquid container 10.

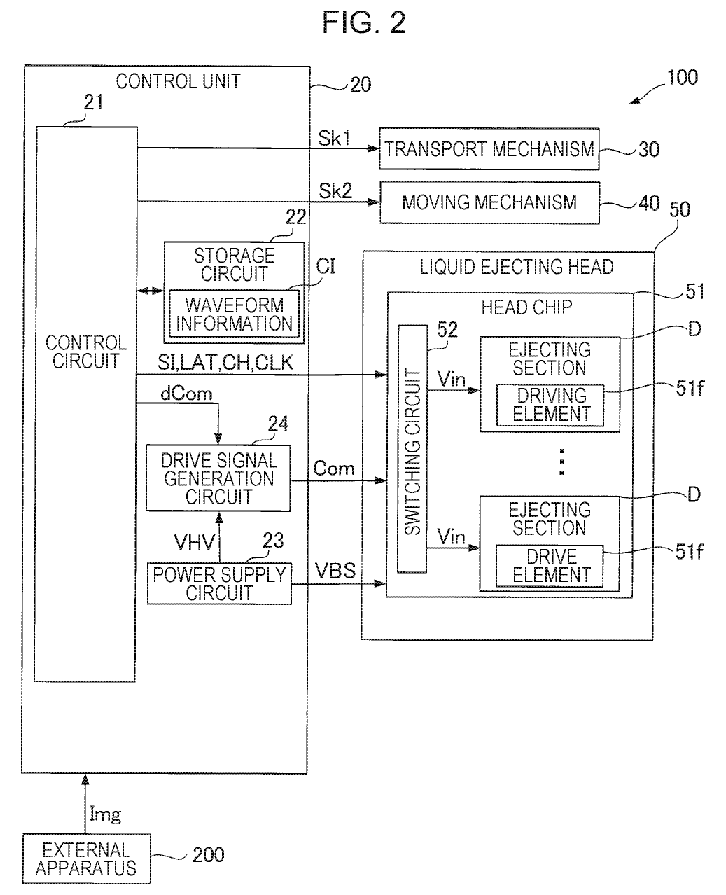

The control unit 20 controls operations of individual elements of the liquid ejecting apparatus 100. The control unit 20 includes, for example, one or a plurality of processing circuits, such as a central processing unit (CPU) or a field-programmable gate array (FPGA), and one or a plurality of storage circuits, such as a semiconductor memory. A detailed configuration of the control unit 20 will be described below with reference to FIG. 2.

The transport mechanism 30 transports the medium PP in the Y1 direction under control by the control unit 20. The moving mechanism 40 reciprocates the liquid ejecting head 50 along the X-axis under the control of the control unit 20. The moving mechanism 40 includes a substantially box-shaped carriage 41 that houses the liquid ejecting head 50, and an endless transport belt 42 to which the carriage 41 is fixed. Note that the number of liquid ejecting heads 50 mounted in the carriage 41 is not limited to one, and may be plural. Furthermore, the liquid container 10 described above may be mounted in the carriage 41, in addition to the liquid ejecting head 50.

The liquid ejecting head 50 ejects the ink supplied from the liquid container 10 onto the medium PP from the individual nozzles N under the control of the control unit 20. The ejection is performed in parallel with the transport of the medium PP by the transport mechanism 30 and the reciprocating movement of the liquid ejecting head 50 by the moving mechanism 40, so that an image is formed by the ink on a surface of the medium PP.

### A2: Electrical Configuration of Liquid Ejecting Apparatus 100

FIG. 2 is a diagram illustrating an electrical configuration of the liquid ejecting apparatus 100 according to the first embodiment. As illustrated in FIG. 2, the liquid ejecting head 50 has one head chip 51. However, the liquid ejecting head 50 may have a plurality of head chips 51.

The head chip 51 includes a switching circuit 52 and M ejecting sections D. In the following, when the number of ejecting sections D included in the head chip 51 is M, in order to individually distinguish the M ejecting sections D, the ejecting sections D may be referred to as ejecting sections D[m] using a subscript [m]. Meanwhile, M is an integer of 2 or more, and m is an integer of 1 or more and M or less. In addition, in the liquid ejecting apparatus 100, elements included in the ejecting sections D may also be described using the subscript [m].

Under the control of the control unit 20, the switching circuit 52 switches whether to supply a drive signal Com output from the control unit 20 to each of the M ejecting sections D as a supply signal Vin. Although the head chip 51 includes the switching circuit 52 in this embodiment, the head chip 51 may not include the switching circuit 52.

The control unit 20 includes a control circuit 21, a storage circuit 22, a power supply circuit 23, and a drive signal generation circuit 24.

The control circuit 21 has a function of controlling operations of the individual sections of the liquid ejecting apparatus 100 and a function of processing various types of data. The control circuit 21 includes, for example, a processor, such as one or more CPUs. Note that the control circuit 21 may include a programmable logic device, such as an FPGA, instead of or in addition to the CPU. In addition, when the control circuit 21 includes a plurality of processors, the plurality of processors may be mounted on different substrates or the like.

Here, by executing the program, the control circuit 21 generates a control signal Sk1 and a control signal Sk2, a print data signal SI, a waveform designation signal dCom, a latch signal LAT, a change signal CH, and a clock signal CLK as signals for controlling operations of the individual sections of the liquid ejecting apparatus 100.

The control signal Sk1 is a signal for controlling driving of the transport mechanism 30. The control signal Sk2 is a signal for controlling driving of the moving mechanism 40. The print data signal SI is a digital signal for designating an operation state of drive elements 51f. The latch signal LAT and the change signal CH are timing signals that are used in combination with the print data signal SI and that define an ink ejection timing from the individual nozzles N of the head chip 51.

Furthermore, the control circuit 21 reads a program stored in the storage circuit 22 and executes the read program, thereby executing the driving method according to this embodiment.

The storage circuit 22 stores various programs to be executed by the control circuit 21, various types of data, such as image data Img to be processed by the control circuit 21, and waveform information CI for generating the waveform designation signal dCom. The storage circuit 22 includes, for example, a semiconductor memory of one or both of a volatile memory, such as a random-access memory (RAM) and a non-volatile memory, such as a read only memory (ROM), an electrically erasable programmable read-only memory (EEPROM), or a programmable ROM (PROM). The image data Img is supplied from an external device 200, such as a personal computer or a digital camera. Note that the storage circuit 22 may be configured as a portion of the control circuit 21.

The power supply circuit 23 receives power supplied from a commercial power supply (not illustrated) and generates various predetermined potentials. The generated various potentials are appropriately supplied to the individual sections of the liquid ejecting apparatus 100. The power supply circuit 23 generates, for example, a power supply potential VHV and an offset potential VBS. The offset potential VBS is supplied to the liquid ejecting head 50. The power supply potential VHV is supplied to the drive signal generation circuit 24.

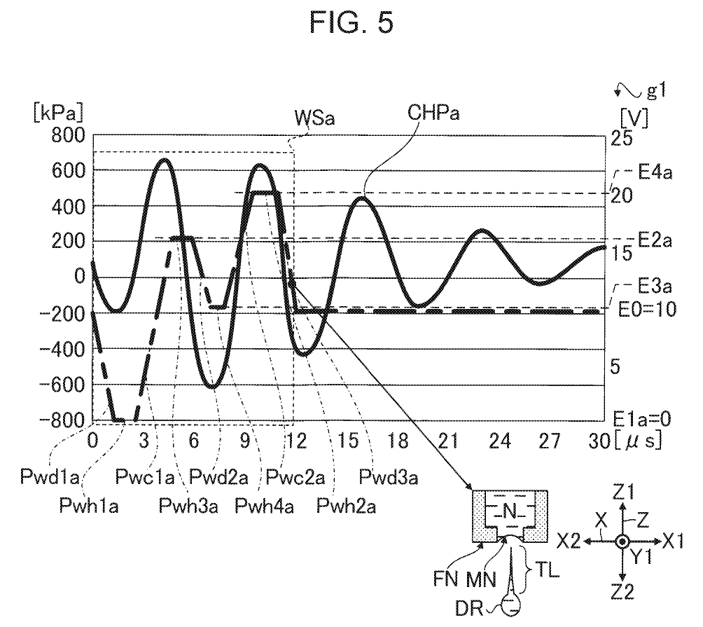

The drive signal generation circuit 24 repeatedly generates the drive signal Com for driving the drive elements 51f included in the ejecting sections D. Specifically, the drive signal generation circuit 24 includes, for example, a DA conversion circuit and an amplifier circuit. In the drive signal generation circuit 24, the DA conversion circuit converts the waveform designation signal dCom supplied from the control circuit 21 from a digital signal to an analog signal. The drive signal Com is generated by the amplifier circuit amplifying the analog signal by using the power supply potential VHV from the power supply circuit 23. Among waveforms included in the drive signal Com, a signal of a waveform actually supplied to the drive elements 51f is the supply signal Vin described above. The waveform designation signal dCom is a digital signal for defining a waveform of the drive signal Com. The control circuit 21 generates the waveform designation signal dCom based on the waveform information CI. Details of the waveform information CI will be described below with reference to FIG. 5.

### A3: Specific Structure of Head Chip 51

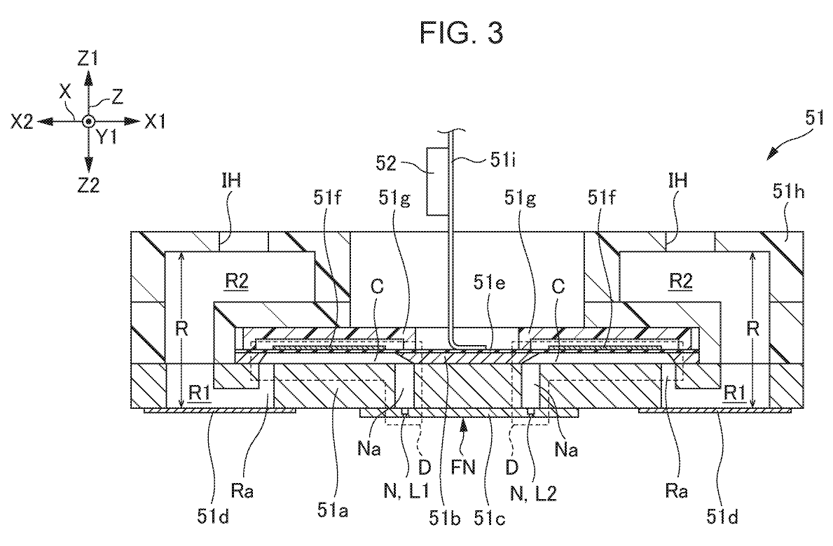

FIG. 3 is a cross-sectional view illustrating an example of the head chip 51. As illustrated in FIG. 3, the head chip 51 has M nozzles N arranged in a direction along the Y-axis. The M nozzles N are divided into a first row L1 and a second row L2 which are arranged at an interval in a direction along the X-axis. Each of the first row L1 and the second row L2 is a set of 0.5 × M nozzles N arranged linearly in a direction along the Y-axis.

The head chip 51 has a substantially symmetrical structure in the direction along the X-axis. Note that, positions of the plurality of nozzles N in the first row L1 and the plurality of nozzles N in the second row L2 in the direction along the Y-axis may match each other or differ from each other. FIG. 3 illustrates a structure in which the positions of the plurality of nozzles N in the first row L1 and the plurality of nozzles N in the second row L2 in the direction along the Y-axis match each other.

As illustrated in FIG. 3, the head chip 51 includes a flow path substrate 51a, a pressure chamber substrate 51b, a nozzle plate 51c, a vibration absorbing body 51d, a vibration plate 51e, the plurality of drive elements 51f, a protective plate 51g, a case 51h, and a wiring substrate 51i.

The flow path substrate 51a and the pressure chamber substrate 51b are stacked in this order in the Z1 direction, and form a flow path for supplying ink to the M nozzles N. The vibration plate 51e, the M drive elements 51f, the protective plate 51g, the case 51h, and the wiring substrate 51i are installed in a region located in the Z1 direction with respect to a stacked body formed by the flow path substrate 51a and the pressure chamber substrate 51b. On the other hand, the nozzle plate 51c and the vibration absorbing body 51d are installed in a region located in the Z2 direction with respect to the stacked body. Each of the components of the head chip 51 is schematically a plate-shaped member elongated in the Y direction, and the components are joined to each other by, for example, using an adhesive. Hereinafter, the individual components of the head chip 51 will be described in order.

The nozzle plate 51c is a plate-shaped member provided with the M nozzles N for each of the first row L1 and the second row L2. Each of the M nozzles N is a through-hole through which the ink passes. These nozzles N are formed on a nozzle surface FN which is a surface facing the Z2 direction of the nozzle plate 51c. The nozzle plate 51c is manufactured by, for example, processing a silicon single crystal substrate by a semiconductor manufacturing technique using a processing technique, such as dry etching or wet etching. Note that other known methods and materials may be used as appropriate for manufacturing the nozzle plate 51c. In addition, although a cross-sectional shape of the nozzle N is typically circular, the cross-sectional shape is not limited to this, and may be, for example, a non-circular shape, such as a polygonal or elliptical shape.

The flow path substrate 51a has a space R1, M supply flow paths Ra, and M communication flow paths Na, for each of the first row L1 and the second row L2. The spaces R1 are elongated openings extending in the direction along the Y-axis in a plan view in the direction along the Z-axis. The supply flow paths Ra and the communication flow paths Na are through-holes individually formed to correspond to the nozzles N. The individual supply flow paths Ra communicates with the corresponding spaces R1.

The pressure chamber substrate 51b is a plate-shaped member having the M pressure chambers C referred to as cavities, for each of the first row L1 and the second row L2. The M pressure chambers C are arranged in the direction along the Y-axis. Each of the pressure chambers C is an elongated space formed for a corresponding one of the nozzles N and extending in the direction along the X-axis in the plan view. The flow path substrate 51a and the pressure chamber substrate 51b are individually manufactured by, for example, processing a silicon single crystal substrate by a semiconductor manufacturing technique in the same manner as the nozzle plate 51c described above. Here, other known methods and materials may be used as appropriate for manufacturing each of the flow path substrate 51a and the pressure chamber substrate 51b.

Each of the pressure chamber C is a space located between the flow path substrate 51a and the vibration plate 51e. For each of the first row L1 and the second row L2, the M pressure chambers C are arranged in the direction along the Y-axis. In addition, the pressure chambers C communicate with the communication flow paths Na and the supply flow paths Ra. Therefore, the pressure chambers C communicate with the nozzles N via the communication flow path Na, and communicate with the spaces R1 via the supply flow paths Ra.

The vibration plate 51e is disposed on a surface of the pressure chamber substrate 51b facing the Z1 direction. The vibration plate 51e is a plate-shaped member that can elastically vibrate. The vibration plate 51e has, for example, a first layer and a second layer, which are stacked in the Z1 direction in this order. The first layer is, for example, an elastic film made of silicon oxide (SiO₂). For example, the elastic film is formed by thermally oxidizing one surface of a silicon single crystal substrate. The second layer is, for example, an insulating film made of a zirconium oxide (ZrO₂). The insulating film is formed, for example, by forming a zirconium layer by a sputtering method and then thermally oxidizing the layer. Note that the vibration plate 51e is not limited to the structure in which the first layer and the second layer are stacked described above, and may be composed of, for example, a single layer or three or more layers.

On the surface of the vibration plate 51e facing the Z1 direction, the M drive elements 51f corresponding to the nozzles N are arranged, for each of the first row L1 and the second row L2. Each of the drive elements 51f is a passive element deformed by the drive signal Com being supplied. The individual drive elements 51f have an elongated shape extending in the direction along the X-axis in the plan view. The M drive elements 51f are arranged in the direction along the Y-axis to correspond to the M pressure chambers C. The drive elements 51f overlap the pressure chambers C in the plan view.

Each of the drive elements 51f is a piezoelectric element, and although not illustrated, each of the drive elements 51f has a first electrode, a piezoelectric layer, and a second electrode, which are stacked in this order in the Z1 direction. One of the first electrode and the second electrode is an individual electrode that is disposed to be separated from each other for each drive element 51f, and the supply signal Vin is applied to the one of the electrodes. The other of the first electrode and the second electrode is a band-shaped common electrode extending in the direction along the Y-axis to be continuous over the 0.5×M drive elements 51f, and the offset potential VBS is supplied to the other of the electrodes. Examples of metal materials of the electrodes include metal materials, such as platinum (Pt), aluminum (Al), nickel (Ni), gold (Au), and copper (Cu), and among these, one type can be used alone, or two or more types can be used in combination in an alloy or stacked aspect. The piezoelectric layer is made of a piezoelectric material, such as lead zirconate titanate (Pb(Zr,Ti)O₃), and for example, has a band shape extending in the direction along the Y-axis to be continuous over 0.5 × the M drive elements 51f. Note that the piezoelectric layer may be integrated over the 0.5×M drive elements 51f. In this case, the piezoelectric layer has a through-hole penetrating the piezoelectric layer to extend in the direction along the X-axis in a region corresponding to, in the plan view, a gap between the pressure chambers C adjacent to each other. When the vibration plate 51e vibrates in conjunction with the above deformation of the drive elements 51f, pressures in the pressure chambers C fluctuate, and the ink is ejected from the nozzles N.

The protective plate 51g is a plate-shaped member installed on the surface of the vibration plate 51e facing the Z1 direction, and protects the M drive elements 51f and reinforce a mechanical strength of the vibration plate 51e. Here, the M drive elements 51f are housed between the protective plate 51g and the vibration plate 51e. For example, the protective plate 51g is made of a resin material.

The case 51h is a member for storing the ink to be supplied to the plurality of M pressure chambers C. For example, the case 51h is made of a resin material. The case 51h has spaces R2 for the respective first and second rows L1 and L2. The spaces R2 communicate with the corresponding spaces R1 described above, and function as reservoirs R for storing ink to be supplied to the M pressure chambers C, together with the spaces R1. The case 51h has inlets IH for supplying the ink to the corresponding reservoirs R. Inks in the individual reservoirs R are supplied to the corresponding pressure chambers C via the corresponding supply flow paths Ra.

The vibration absorbing body 51d is also referred to as a compliance substrate, is a flexible resin film forming wall surfaces of the reservoirs R, and absorb the pressure fluctuation of the ink in the reservoirs R. The vibration absorbing body 51d may be a flexible thin plate made of metal. A surface of the vibration absorbing body 51d facing the Z1 direction is joined to the flow path substrate 51a by using an adhesive or the like.

The wiring substrate 51i is mounted on a surface of the vibration plate 51e facing the Z1 direction, and is a mounting component for electrically coupling the control unit 20 and the head chip 51. The wiring substrate 51i is, for example, a flexible wiring substrate, such as a chip on film (COF), a flexible printed circuit (FPC), or a flexible flat cable (FFC). The switching circuit 52 for supplying a drive voltage to the individual drive elements 51f is mounted on the wiring substrate 51i of this embodiment.

As illustrated in FIG. 3, one of the ejecting sections D includes one drive element 51f, one pressure chamber C, and one nozzle N. That is, the M drive elements 51f correspond to the M pressure chambers C on a one-to-one basis. As understood from FIG. 3 and the like, the term "the drive elements 51f corresponding to the pressure chambers C" indicates the drive elements 51f that overlap portions or the entirety of the corresponding pressure chambers C in the plan view in the Z2 direction. When the drive signal Com is supplied to the drive elements 51f based on the print data signal SI, the ejecting sections D eject the ink in the pressure chambers C from the nozzles N by driving the drive elements 51f with the drive signal Com.

### A4: Driving of Drive Element 51f

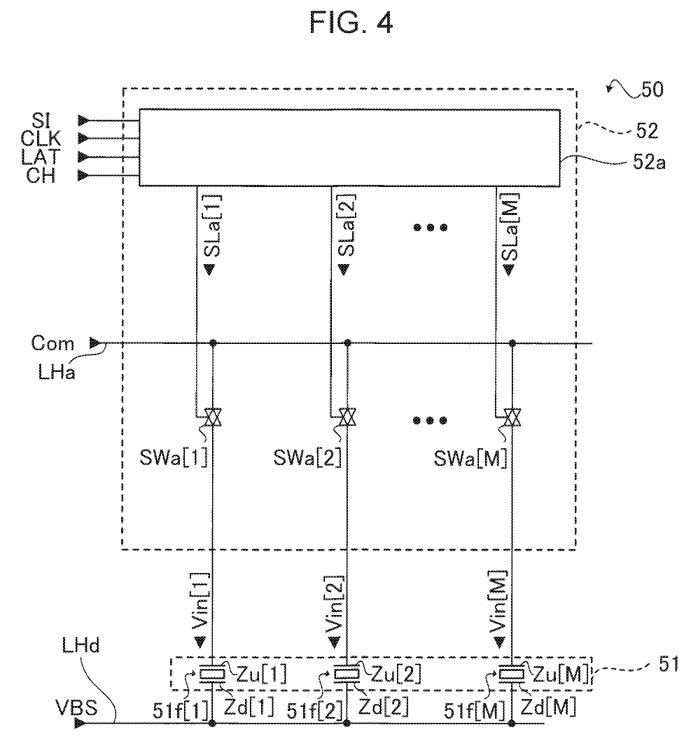

FIG. 4 is a diagram for describing the switching circuit 52. The drive elements 51f are driven by the supply signal Vin supplied from the switching circuit 52. Hereinafter, the switching circuit 52 will be described with reference to FIG. 4.

As illustrated in FIG. 4, a wiring line LHa is connected to the switching circuit 52. The wiring line LHa is a signal line that transmits the drive signal Com. In FIG. 4, for each of the integers m from 1 to M, the first electrodes or the second electrodes of the drive elements 51f described above are illustrated as electrodes Zd[m], and the others are illustrated as electrodes Zu[m]. A wiring line LHd is connected to the electrodes Zd[m]. The wiring line LHd is a power supply line to which the offset potential VBS is supplied.

The switching circuit 52 includes M switches SWa, which are switches SWa[1] to SWa[M], and a connection state designation circuit 52a that designates connection states of the switches.

For each of the integers m from 1 to M, the switches SWa[m] switch between conduction and non-conduction between the wiring line LHa for transmitting the drive signal Com and the electrodes Zu[m] of the drive elements 51f[m]. Each of these switches is, for example, a transmission gate.

The connection state designation circuit 52a generates connection state designation signals SLa[1] to SLa[M] for designating ON or OFF of the switches SWa[1] to SWa[M] based on the clock signal CLK, the print data signal SI, the latch signal LAT, and the change signal CH supplied from the control circuit 21.

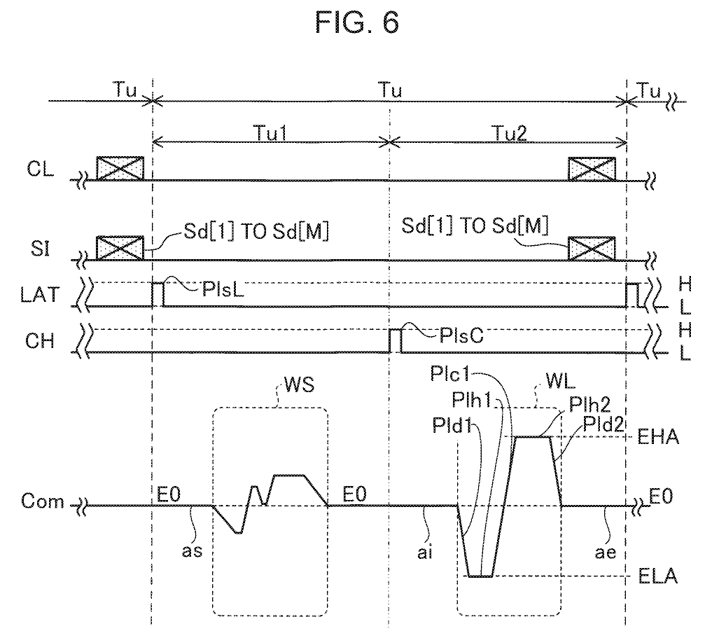

For example, although not illustrated, the connection state designation circuit 52a includes a plurality of transfer circuits, a plurality of latch circuits, and a plurality of decoders such that sets of the plurality of transfer circuits, the plurality of latch circuits, and the plurality of decoders correspond to the drive elements 51f[1] to 51f[M] on a one-to-one basis. Among these, the print data signal SI is supplied to the transfer circuits. Here, the print data signal SI includes individual designation signals Sd illustrated in FIG. 6 for the respective drive elements 51f. The individual designation signals Sd are serially supplied, and for example, the individual designation signals Sd are sequentially transferred to the plurality of transfer circuits in synchronization with the clock signal CLK. Furthermore, the latch circuits latch the individual designation signals Sd supplied to the transfer circuits based on the latch signal LAT. In addition, the decoders generate connection state designation signals SLa[m], connection state designation signals SLb[m], and connection state designation signals SLc[m], for the individual integers m from 1 to M, based on the individual designation signals Sd and the latch signal LAT.

For the individual integers m from 1 to M, the switches SWa[m] are switched between ON and OFF according to the connection state designation signals SLa[m] generated as described above. For example, each of the switches SWa[m] is in an on state when a corresponding one of the connection state designation signals SLa[m] is at a high level and is in an off state when a corresponding one of the connection state designation signals SLa[m] is at a low level. As described above, the switching circuit 52 supplies a portion or an entirety of a waveform included in the drive signal Com as the supply signal Vin to the drive elements 51f of one or more ejecting sections D selected from the M ejecting sections D.

### A5: MIST

In order to improve the ejection performance which is one or both of an ejection amount and an ejection speed of the ink ejected from the nozzles N, it is considered that the drive signal Com having an ejection pulse based on a natural period Tc of the ejecting sections D is generated. The ejection pulse causes ink to be ejected from the nozzles N.

In addition, when the ink is ejected, fine atomized ink droplets, so-called mist, may be generated due to tailing of the ejected ink. When the mist is generated, the mist adheres to peripheries of the nozzles N, which may cause deterioration of the ejection performance and ejection failure.

In addition, the drive signal Com may have a large dot ejection pulse for ejecting an amount of ink corresponding to a large dot and a small dot ejection pulse for ejecting an amount of ink corresponding to a small dot. Hereinafter, the large dot ejection pulse and the small dot ejection pulse may be referred to as an ejection pulse without distinction. As a result of experiments conducted by the inventors, it has been found that mist may be generated in the ejection pulse when an ejection speed of the ejection pulse is to be secured to a level desired by a manufacturer of the liquid ejecting head 50. Hereinafter, the ejection pulses may be referred to as comparative ejection pulses. Furthermore, each of two types of comparative ejection pulse may be referred to as a comparative large dot ejection pulse and a comparative small dot ejection pulse. In addition, the manufacturer of the liquid ejecting head 50 may be referred to as a head maker. The reason that mist is generated in the comparative small dot ejection pulse will be described with reference to FIG. 5.

FIG. 5 is a diagram for explaining the reason that mist is generated in the comparative small dot ejection pulse. A graph g1 illustrated in FIG. 5 indicates a potential of a comparative small dot ejection pulse WSa and a pressure of ink in one of the ejecting sections D. A pressure characteristic CHPa illustrated in the graph g1 illustrates a pressure characteristic of the ink inside the ejecting section D when the comparative small dot ejection pulse WSa is supplied to the ejecting section D. A horizontal axis of the graph g1 represents time, a vertical axis of the graph g1 represents a potential with respect to the small dot ejection pulse WSa, and the vertical axis of the graph g1 represents a pressure with respect to the pressure in the ink. In the graph g1, [μs] indicates microseconds, which is a unit of time, [V] indicates volts, which is a unit of potential, and [kPa] indicates kilopascals, which is a unit of pressure.

The comparative small dot ejection pulse WSa has a first depressurized-potential change component Pwd1a, a first potential holding component Pwh1a, a first pressurized-potential change component Pwc1a, a third potential holding component Pwh3a, a second depressurized-potential change component Pwd2a, a fourth potential holding component Pwh4a, a second pressurized-potential change component Pwc2a, a second potential holding component Pwh2a, and a third depressurized-potential change component Pwd3a. Hereinafter, the first depressurized-potential change component Pwd1a, the second depressurized-potential change component Pwd2a, and the third depressurized-potential change component Pwd3a may be referred to as depressurized-potential change components Pwda without distinction. The first pressurized-potential change component Pwc1a and the second pressurized-potential change component Pwc2a may be referred to as pressurized-potential change components Pwca without distinction. The first potential holding component Pwh1a, the third potential holding component Pwh3a, the fourth potential holding component Pwh4a, and the second potential holding component Pwh2a may be referred to as potential holding components Pwha without distinction.

The depressurized-potential change component Pwda drives the drive elements 51f so as to reduce the pressure of the ink in the pressure chambers C. The pressurized-potential change component Pwca drives the drive elements 51f so as to increase the pressure of the ink in the pressure chambers C. The potential holding component Pwha maintains a potential from a start end to a terminal end of the potential holding component Pwha.

A start end of the first depressurized-potential change component Pwd1a coincides with a start end of the small dot ejection pulse WSa. The first depressurized-potential change component Pwd1a changes from a reference potential E0, which is a start potential of the small dot ejection pulse WSa, to a potential E1a, and generates a negative pressure in the pressure chambers C. The reference potential E0 is approximately 9.6 [V]. The potential E1a is approximately 0 [V]. A potential change rate of the first depressurized-potential change component Pwd1a is larger than 2 V/μsec. The potential change rate is a value obtained by dividing a potential change range by a length of a period of time in which the potential changes. The potential change range is a potential difference between a potential at a start time of the period of time in which the potential changes and a potential at an end time. In this specification, a potential difference between two potentials is an absolute value of a value obtained by subtracting a value of one of the potentials from a value of the other of the potentials.

The first potential holding component Pwh1a is connected to a terminal end of the first depressurized-potential change component Pwd1a and maintains the potential E1a. The first pressurized-potential change component Pwc1a is connected to a terminal end of the first potential holding component Pwh1a, and changes from the potential E1a to a potential E2a to generate a positive pressure in the pressure chambers C. The potential E2a is approximately 16 [V]. The third potential holding component Pwh3a is connected to a terminal end of the first pressurized-potential change component Pwc1a and maintains the potential E2a. The second depressurized-potential change component Pwd2a changes from the potential E2a to a potential E3a to generate a negative pressure in the pressure chambers C. The potential E3a is approximately 10.3 [V]. The fourth potential holding component Pwh4a is connected to a terminal end of the second depressurized-potential change component Pwd2a and maintains the potential E3a. The second pressurized-potential change component Pwc2a is connected to a terminal end of the fourth potential holding component Pwh4a, and changes from the potential E3a to a potential E4a to generate a positive pressure in the pressure chambers C. The potential E4a is approximately 20 [V]. The second potential holding component Pwh2a is connected to a terminal end of the second pressurized-potential change component Pwc2a and maintains the potential E4a. The third depressurized-potential change component Pwd3a is connected to a terminal end of the second potential holding component Pwh2a, and changes from the potential E4a to the reference potential E0 to generate a negative pressure in the pressure chambers C.

Furthermore, in FIG. 5, a state where an ink droplet DR is ejected from one of the nozzles N is illustrated. More specifically, a liquid column (not illustrated) along the Z-axis is formed on a meniscus MN which is a liquid surface of the nozzle N, and the liquid column is divided so that the ink droplet DR is ejected. When the liquid column is cut, a tail TL is formed in the ink droplet DR. Furthermore, as understood from FIG. 5, the meniscus MN is pulled in the Z1 direction when the third depressurized-potential change component Pwd3a is supplied to a corresponding one of the drive elements 51f. Therefore, force toward the Z1 direction acts on a position of the liquid column in the Z1 direction, that is, a root portion of the liquid column, while force toward the Z2 direction acts on a tip portion of the liquid column in the Z2 direction. Therefore, since the two forces directed in the opposite directions to each other act on the liquid column, it has been obtained by the experiment of the inventors that a large amount of mist is generated when the head maker tries to secure a desired ejection speed.

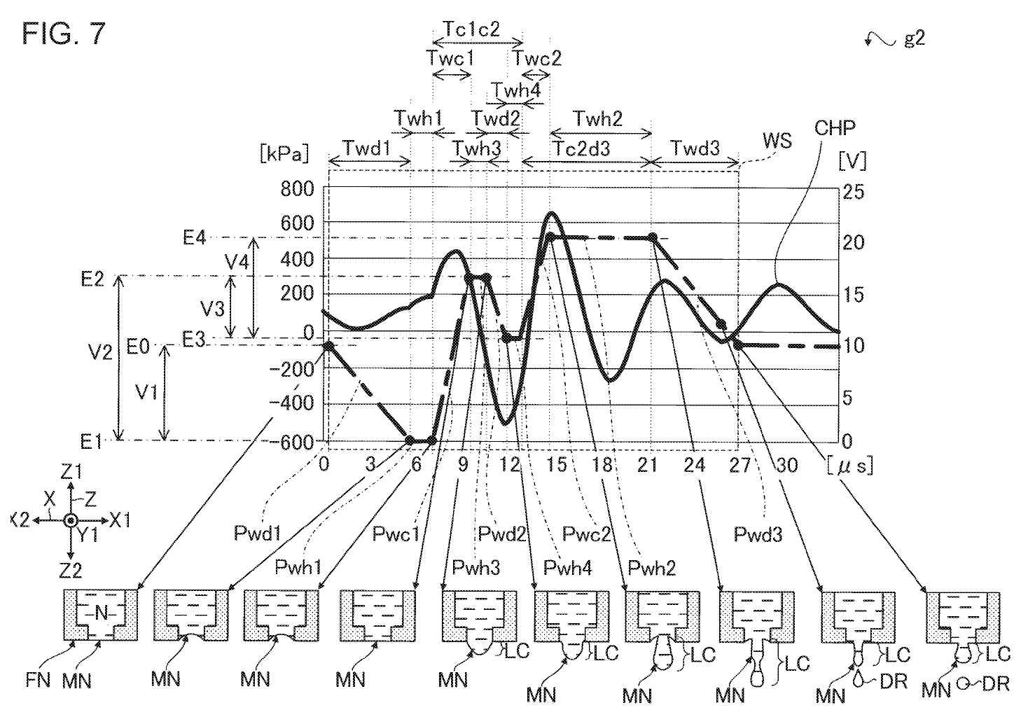

Therefore, in this embodiment, an amount of generated mist is suppressed by adjusting a timing at which the liquid column is divided. The drive signal Com including the small dot ejection pulse WS in this embodiment will be described with reference to FIGS. 6 and 7.

### A6: Drive Signal Com

FIG. 6 is a diagram explaining the drive signal Com for generating the supply signal Vin to be supplied to the head chip 51. In this embodiment, an operation period of the liquid ejecting apparatus 100 includes one or a plurality of unit periods Tu. Note that, in general, the liquid ejecting apparatus 100 forms an image indicated by the image data Img by ejecting liquid once or a plurality of times from the individual ejecting sections D over the plurality of unit periods Tu continuously or intermittently.

As illustrated in FIG. 6, the control circuit 21 outputs the latch signal LAT having a pulse PlsL and the change signal CH having a pulse PlsC. Therefore, the control circuit 21 defines the unit period Tu as a period from a rising edge of a pulse PlsL to a rising edge of a next pulse PlsL. A specific length or a period of the unit period Tu is not particularly limited. The control circuit 21 divides the unit period Tu into two control periods Tu1 and Tu2 by the pulse PlsC.

The print data signal SI includes the individual designation signals Sd[1] to Sd[M] that designate modes of driving of the ejecting sections D[1] to D[M] in each unit period Tu. As described above, the connection state designation circuit 52a generates the connection state designation signal SLa[m] based on the individual designation signal Sd[m] in the unit period Tu, for each of the integers m from 1 to M.

The individual designation signal Sd[m] designates any one of three driving modes, that is, a mode of ejection of ink of an amount corresponding to a large dot, a mode of ejection of ink of an amount corresponding to a small dot, and a mode of non-ejection, with respect to the ejecting section D [m] in each unit period Tu.

As illustrated in FIG. 6, the drive signal generation circuit 24 outputs the drive signal Com having a start potential holding component as, a small dot ejection pulse WS, a connection component ai, a large dot ejection pulse WL, and an end potential holding component ae in this order in one unit period Tu. The start potential holding component as, the small dot ejection pulse WS, and a portion including a start time point of the connection component ai are included in the control period Tu1. A portion including an end point of the connection component ai, the large dot ejection pulse WL, and the end potential holding component ae are included in the control period Tu2.

The start potential holding component as maintains the reference potential E0 from a start of one unit period Tu to a start of the small dot ejection pulse WS. The connection component ai maintains the reference potential E0 from an end of the small dot ejection pulse WS to a start of the large dot ejection pulse WL. The end potential holding component ae maintains the reference potential E0 from an end of the large dot ejection pulse WL to an end of one unit period Tu.

Individual components included in the small dot ejection pulse WS will be described with reference to FIG. 7. The large dot ejection pulse WL has a filling component Pld1, a potential holding component Plh1, an ejection component Plc1, a vibration damping holding component Plh2, and a vibration damping expansion component Pld2 in this order. The potential of the filling component Pld1 changes from the reference potential E0 to a lowest potential ELA to generate a negative pressure in the pressure chamber C. The lowest potential ELA is a lowest potential in the large dot ejection pulse WL. A terminal end of the filling component Pld1 is connected to a start end of the potential holding component Plh1. The potential holding component Plh1 maintains the lowest potential ELA. A terminal end of the potential holding component Plh1 is connected to the ejection component Plc1. The ejection component Plc1 changes from the lowest potential ELA to a highest potential EHA to generate a positive pressure in the pressure chambers C. The highest potential EHA is a highest potential in the large dot ejection pulse WL. When receiving supply of the ejection component Plc1, the drive elements 51f eject ink droplets from the nozzles N. The vibration damping holding component Plh2 maintains the highest potential EHA from a terminal end of the ejection component Plc1. The vibration damping expansion component Pld2 starts potential change from a terminal end of the vibration damping holding component Plh2 to expand the pressure chambers C. The vibration damping expansion component Pld2 changes the potential from the highest potential EHA to the reference potential E0.

When the individual designation signal Sd[m] designates ejection of the ink corresponding to a small dot to the ejecting section D[m] for each of the integers m from 1 to M, the connection state designation circuit 52a sets the individual designation signal Sd[m] to a high level in the control period Tu1 and to a low level in the control period Tu2. In this case, the ejecting section D[m] is driven by the small dot ejection pulse WS in the control period Tu1 to eject ink of an amount corresponding to a small dot.

When the individual designation signal Sd[m] designates ejection of the ink of an amount corresponding to a large dot to the ejecting section D[m] for each of the integers m from 1 to M, the connection state designation circuit 52a sets the individual designation signal Sd[m] to a low level in the control period Tu1 and to a high level in the control period Tu2. In this case, the ejecting section D[m] is driven by the large dot ejection pulse WL in the control period Tu2 to eject ink.

Note that, in FIG. 6, the unit period Tu is divided into the two control periods Tu1 and Tu2, and the drive signal Com has one ejection pulse for each of the control period Tu1 and the control period Tu2, but the present disclosure is not limited thereto. For example, the drive signal Com may have two systems of signals, that is, a drive signal Com-A and a drive signal Com-B, one of the signals may have the small dot ejection pulse WS, and the other of the signals may have the large dot ejection pulse WL.

FIG. 7 is a diagram for explaining individual components of the small dot ejection pulse WS. Furthermore, a graph g2 illustrated in FIG. 7 indicates a potential of the small dot ejection pulse WS and a pressure of the ink in one of the ejecting sections D. A pressure characteristic CHP illustrated in the graph g2 indicates a characteristic of the pressure of the ink inside the ejecting section D when the small dot ejection pulse WS is supplied to the ejecting section D.

The small dot ejection pulse WS has a first depressurized-potential change component Pwd1, a first potential holding component Pwh1, a first pressurized-potential change component Pwc1, a third potential holding component Pwh3, a second depressurized-potential change component Pwd2, a fourth potential holding component Pwh4, a second pressurized-potential change component Pwc2, a second potential holding component Pwh2, and a third depressurized-potential change component Pwd3 in this order. Hereinafter, the first depressurized-potential change component Pwd1, the second depressurized-potential change component Pwd2, and the third depressurized-potential change component Pwd3 may be referred to as depressurized-potential change components Pwd without distinction. The first pressurized-potential change component Pwc1 and the second pressurized-potential change component Pwc2 may be referred to as a pressurized-potential change components Pwc without distinction. The first potential holding component Pwh1, the third potential holding component Pwh3, the fourth potential holding component Pwh4, and the second potential holding component Pwh2 may be referred to as potential holding components Pwh without distinction. Note that the small dot ejection pulse WS is an example of a "first ejection pulse".

The depressurized-potential change component Pwd drives the drive element 51f so as to reduce the pressure of the ink in the pressure chamber C. The pressurized-potential change component Pwc drives the drive element 51f so as to increase the pressure of the ink in the pressure chamber C. The potential holding component Pwh maintains the potential from a start end to a terminal end of the potential holding component Pwh. The potential E1 maintained by the first potential holding component Pwh1 is substantially the same as the potential E1a. The potential E2 maintained by the third potential holding component Pwh3 is substantially the same as the potential E2a. The potential E3 maintained by the fourth potential holding component Pwh4 is substantially the same as the potential E3a. The potential E4 maintained by the second potential holding component Pwh2 is substantially the same as the potential E4a.

The waveform information CI illustrated in FIG. 2 defines the small dot ejection pulse WS and the large dot ejection pulse WL included in the drive signal Com. Specifically, the waveform information CI has terminal end information including information indicating time points of the terminal ends of the individual components included in the drive signal Com and information indicating the potentials of the terminal ends. For example, the waveform information CI includes terminal end information of the start potential holding component as, terminal end information of the small dot ejection pulse WS, terminal end information of the connection component ai, terminal end information of the large dot ejection pulse WL, and terminal end information of the end potential holding component ae. The terminal end information of the small dot ejection pulse WS includes terminal end information of the first depressurized-potential change component Pwd1, terminal end information of the first potential holding component Pwh1, terminal end information of the first pressurized-potential change component Pwc1, terminal end information of the third potential holding component Pwh3, terminal end information of the second depressurized-potential change component Pwd2, terminal end information of the fourth potential holding component Pwh4, terminal end information of the second pressurized-potential change component Pwc2, terminal end information of the second potential holding component Pwh2, and terminal end information of the third depressurized-potential change component Pwd3. The terminal end information of the large dot ejection pulse WL includes terminal end information of the filling component Pld1, terminal end information of the potential holding component Plh1, terminal end information of the ejection component Plc1, terminal end information of the vibration damping holding component Plh2, and terminal end information of the vibration damping expansion component Pld2. Information indicating a time point of the terminal end included in the terminal end information of the end potential holding component ae indicates the one unit period Tu.

Lengths of periods of the individual components included in the small dot ejection pulse WS will be described. For example, a period Twd1 of the first depressurized-potential change component Pwd1 is 0.63 times as long as Tc. A period Twh1 of the first potential holding component Pwh1 is 0.15 times as long as Tc. A period Twc1 of the first pressurized-potential change component Pwc1 is 0.26 times as long as Tc. A period Twh3 of the third potential holding component Pwh3 is 0.16 times as long as Tc. A period Twd2 of the second depressurized-potential change component Pwd2 is 0.14 times as long as Tc. A period Twh4 of the fourth potential holding component Pwh4 is 0.10 times as long as Tc. A period Twc2 of the second pressurized-potential change component Pwc2 is 0.20 times as long as Tc. A period Twh2 of the second potential holding component Pwh2 is 0.76 times as long as Tc. A period Twd3 of the third depressurized-potential change component Pwd3 is 0.63 times as long as Tc. Hereinafter, differences from components of the comparative small dot ejection pulse WSa will be described.

A potential change range V1 of the first depressurized-potential change component Pwd1 is 40% or more of a potential change range V2 of the first pressurized-potential change component Pwc1. The potential change range V1 is a potential difference between the reference potential E0 and the potential E1. The potential change range V2 is a potential difference between the potential E1 and the potential E2. For example, the potential change range V1 is 60% of the potential change range V2.

A potential change rate of the first depressurized-potential change component Pwd1 is 1 V/μsec or more and 2 V/μsec or less. The potential change rate of the first depressurized-potential change component Pwd1 is a value obtained by dividing the potential change range V1 by the period Twd1 of the first depressurized-potential change component Pwd1. The potential change rate of the first depressurized-potential change component Pwd1 is 1.92 V/μsec.

Furthermore, the period Twh1 of the first potential holding component Pwh1 and the period Twh3 of the third potential holding component Pwh3 are not less than 0.1 times and not more than 0.25 times Tc. For example, the period Twh1 is 0.15 times Tc as described above, and the period Twh3 is 0.16 times Tc as described above.

A potential change rate of the first pressurized-potential change component Pwc1 is 4 V/μsec or more. For example, the potential change rate of the first pressurized-potential change component Pwc1 is 7.62 V/μsec. In addition, a potential change rate of the second depressurized-potential change component Pwd2 and a potential change rate of the second pressurized-potential change component Pwc2 are also preferably 4 V/μsec or more. For example, the potential change rate of the second depressurized-potential change component Pwd2 is 5.45 V/μsec. The potential change rate of the second pressurized-potential change component Pwc2 is 6.25 V/μsec. On the other hand, a potential change rate of the third depressurized-potential change component Pwd3 is 2.08 V/μsec, which is less than 4 V/μsec.

Furthermore, the period Twd1 of the first depressurized-potential change component Pwd1 is equal to or less than Tc. For example, the period Twd1 is 0.63 times Tc as described above.

Moreover, a period Tc2d3 from a start end of the second pressurized-potential change component Pwc2 to a start end of the third depressurized-potential change component Pwd3 is 0.75 times or more of Tc. For example, the period Tc2d3 is 0.96 times Tc.

Furthermore, a period Tc1c2 from a start of the first pressurized-potential change component Pwc1 to a start of the second pressurized-potential change component Pwc2 is a period of 0.5 times or more and 0.75 times or less of Tc. For example, the period Tc1c2 is 0.66 times Tc.

Furthermore, the potential change range V4 of the second pressurized-potential change component Pwc2 is 50% or more and 70% or less of the potential change range V2 of the first pressurized-potential change component Pwc1. The potential change range V4 is a potential difference between the potential E3 and the potential E4. For example, the potential change range V4 is 63% of the potential change range V2.

Furthermore, the period Twh2 of the second potential holding component Pwh2 is 0.5 times or more of Tc. For example, the period Twh2 is 0.76 times Tc.

The potential change range V3 of the second depressurized-potential change component Pwd2 is 20% or more and 50% or less of the potential change range V2. The potential change range V3 is a potential difference between the potential E2 and the potential E3. For example, the potential change range V3 is 38% of the potential change range V2.

This will be described by comparing the pressure characteristic CHP with the pressure characteristic CHPa. Since the potential change rate of the first depressurized-potential change component Pwd1a in the comparative example is larger than 2 V/μsec, as indicated by the voltage characteristic CHPa, a pressure oscillation generated in the ink in the ejecting section D becomes large. To be more specific, as indicated by the pressure characteristic CHPa, from a start time point of the first depressurized-potential change component Pwd1a to an end time point of the first pressurized-potential change component Pwc1a, the ink pressure decreases to approximately -200 kPa and then increases to approximately 650 kPa. On the other hand, since the potential change rate of the first depressurized-potential change component Pwd1 of this embodiment is 1 V/μsec or more and 2 V/μsec or less, as indicated by the pressure characteristic CHP, a magnitude of the pressure oscillation generated in the ink in the ejecting section D is suppressed as compared with the comparative example. Specifically, as indicated by the pressure characteristics CHP, the ink pressure decreases to approximately 0 kPa and then increases to approximately 450 kPa from the start time point of the first depressurized-potential change component Pwd1 to the end time point of the first pressurized-potential change component Pwc1. However, an amplitude of the pressure oscillation of the ink in the pressure characteristic CHP is smaller than an amplitude of the pressure oscillation of the ink in the pressure characteristic CHPa.

Furthermore, in FIG. 7, a state of one of the menisci MN in the nozzles N in a state where the individual components of the small dot ejection pulse WS are supplied to the drive element 51f is illustrated. At a start time point of the first depressurized-potential change component Pwd1, the meniscus MN is positioned substantially parallel to an XY plane. At a start point of the first potential holding component Pwh1, the meniscus MN is pulled in the Z1 direction by the first depressurized-potential change component Pwd1, and a tip of a central portion of the meniscus MN is positioned further in the Z1 direction than the nozzle surface FN. Although the tip of the central portion of the meniscus MN gradually moves in the Z2 direction during the period of the first potential holding component Pwh1, the tip of the meniscus MN is positioned further in the Z1 direction than the nozzle surface FN even at a start time point of the first pressurized-potential change component Pwc1.

The meniscus MN is pushed out in the Z2 direction by the first pressurized-potential change component Pwc1, and the meniscus MN is positioned in the vicinity of an opening of the nozzle N at a start time point of the third potential holding component Pwh3. At a start time point of the second depressurized-potential change component Pwd2, the meniscus MN pushed out in the Z2 direction by the first pressurized-potential change component Pwc1 forms a liquid column LC protruding in the Z2 direction.

At a start time point of the fourth potential holding component Pwh4, the second depressurized-potential change component Pwd2 applies force in the Z1 direction to a root portion of the liquid column LC, and force in the Z2 direction to a tip portion of the liquid column LC in the Z2 direction. Therefore, the two forces directing opposite to each other are applied in the liquid column LC, and the liquid column LC grows along the Z-axis.

Thereafter, the ink in the nozzle N is again pushed out in the Z2 direction by the second pressurized-potential change component Pwc2. At a start time point of the second potential holding component Pwh2, the liquid column LC grows along the Z-axis direction while the tip portion continues to move in the Z2 direction. During the period of the second potential holding component Pwh2, the ink is pushed out from the nozzle N to the root portion of the liquid column LC by the second pressurized-potential change component Pwc2. Furthermore, at a start time point of the third depressurized-potential change component Pwd3, the ink pushed out by the second pressurized-potential change component Pwc2 at the root portion of the liquid column LC moves toward the tip portion of the liquid column LC, and the tip portion of the liquid column LC also moves in the Z2 direction, so that the liquid column LC grows thin and long along the Z-axis direction.

While the third depressurized-potential change component Pwd3 is supplied and the ink in the nozzle N is drawn in the Z1 direction, the liquid column LC is divided between the ink pushed out by the second pressurized-potential change component Pwc2 and the tip portion, and an ink droplet DR is ejected. At a time point when the liquid column LC is divided, the root portion of the liquid column LC moves in the Z1 direction, but the division of the liquid column LC occurs mainly by the action of the surface tensions at a portion where the two forces directed in the directions opposite to each other between the ink pushed out by the second pressurized-potential change component Pwc2 and the tip portion do not act. After the second pressurized-potential change component Pwc2, by setting the period Twh2 of the second potential holding component Pwh2 to be equal to or more than 0.5 times of Tc, the liquid column LC is constricted at a dividing position due to a speed distribution of the tip, the central portion, and the root portion of the liquid column LC without applying a pulling force to the liquid column LC in the Z1 direction due to a displacement of the drive element 51f while the tip portion of the liquid column LC is moving in the Z2 direction, and the tip portion of the liquid column LC is divided as the ink droplet DR. For this reason, compared to the comparative example, generation of mist may be suppressed in this embodiment.

At an end time point of the third depressurized-potential change component Pwd3, the ink droplet DR has moved in the Z2 direction, and the tip of the liquid column LC that has separated from the ink droplet DR has moved in the Z1 direction.

### A7: Operation of First Embodiment

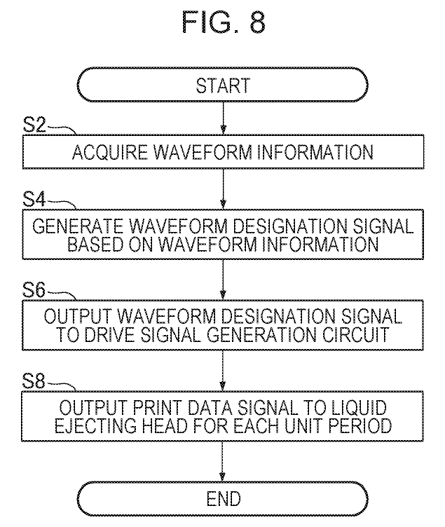

FIG. 8 is a flowchart illustrating an operation of the liquid ejecting apparatus 100 according to the first embodiment. A series of processes illustrated in FIG. 8 is executed when the image data Img is received from the external device 200. In step S2, the control circuit 21 acquires waveform information CI from the storage circuit 22. Next, in step S4, the control circuit 21 generates a waveform designation signal dCom based on the waveform information CI. Then, in step S6, the control circuit 21 outputs the waveform designation signal dCom to the drive signal generation circuit 24. By executing step S6, the drive signal generation circuit 24 outputs a drive signal Com to the liquid ejecting head 50. The control circuit 21 outputs the waveform designation signal dCom to the drive signal generation circuit 24, thereby causing the drive signal generation circuit 24 to supply the drive signal Com to the ejecting section D. After completion of the process of step S6, in step S8, the control circuit 21 outputs the print data signal SI generated based on the image data Img to the liquid ejecting head 50 for each unit period Tu. For any m from 1 to M, it is assumed that the individual designation signal Sd[m] included in the print data signal SI designates ejection of an amount of ink corresponding to a small dot. In this assumption, the drive signal generation circuit 24 supplying the first depressurized-potential change component Pwd1 included in the small dot ejection pulse WS to the drive element 51f of the ejecting section D[m] is an example of a "first step", and supplying the first pressurized-potential change component Pwc1 included in the small dot ejection pulse WS to the drive element 51f of the ejecting section D[m] is an example of a "second step". When an image is formed on the medium PP by performing step S8 a plurality of times, the control circuit 21 terminates the series of processes illustrated in FIG. 8.

### A8: Summary of First Embodiment

The liquid ejecting apparatus 100 includes the nozzles N which eject ink, the pressure chambers C which communicate with the nozzles N, the ejecting sections D which have the drive elements 51f driven so that pressure fluctuation occurs in the ink in the pressure chambers C according to the supplied drive signal Com, and the drive signal generation circuit 24 which generates the drive signal Com. The drive signal Com includes the small dot ejection pulse WS for ejecting ink from the nozzles N. The small dot ejection pulse WS has the first depressurized-potential change component Pwd1 for driving the drive elements 51f so as to reduce pressure of the ink in the pressure chambers C, and the first pressurized-potential change component Pwc1 for driving the drive elements 51f so as to increase the pressure of the ink in the pressure chambers C so that the liquid surface protrudes from the nozzles N after the first depressurized-potential change component Pwd1. The potential change range V1 of the first depressurized-potential change component Pwd1 is 40% or more of the potential change range V2 of the first pressurized-potential change component Pwc1, and the potential change rate of the first depressurized-potential change component Pwd1 is 1 V/μsec or more and 2 V/μsec or less.

The first embodiment can also be defined as a method for driving the liquid ejecting apparatus 100 including the ejecting sections D and the drive signal generation circuit 24. The drive signal generation circuit 24 executes a step of supplying the first depressurized-potential change component Pwd1 to the drive elements 51f of the ejecting sections D and a step of supplying the first pressurized-potential change component Pwc1 to the drive elements 51f of the ejecting sections D.

In the mode in which the potential change rate of the first depressurized-potential change component Pwd1 is larger than 2 V/μsec, as illustrated in the comparative example, the amplitude of the pressure oscillation generated in the ink in the ejecting sections D become large, and tailing is likely to occur. On the other hand, in the mode in which the potential change rate of the first depressurized-potential change component Pwd1 is less than 1 V/μsec, it takes time to sufficiently fill the pressure chambers C with ink, and the amplitude of the pressure oscillation generated in the ink in the ejecting sections D become excessively small. When the amplitude of the pressure oscillation generated in the ink in the ejecting sections D become excessively small, it becomes difficult to secure the speeds of the ink droplets DR separated from the menisci MN in the first pressurized-potential change component Pwc1 after the first depressurized-potential change component Pwd1. As described above, according to the first embodiment, before the menisci MN protrude, the pressure chambers C are sufficiently filled with the ink, and the amplitude of the pressure oscillation generated in the ink in the ejecting sections D is not excessively increased. Therefore, it is possible to secure the ejection speed of the ink droplets DR after being separated from the menisci MN while reducing the tailings TL.

In addition, the small dot ejection pulse WS further includes the first potential holding component Pwh1 which connects the terminal end of the first depressurized- potential change component Pwd1 and the start end of the first pressurized-potential change component Pwc1 and maintains the potential E1 as a predetermined potential. The first potential holding component Pwh1 is a period of 0.1 times or more and 0.25 times or less of Tc.

In a mode in which the first potential holding component Pwh1 is a period longer than 0.25 times Tc, a timing at which the ink in the ejecting sections D is pressurized by supply of the first pressurized-potential change component Pwc1 overlaps a timing at which the pressure of the ink in the ejecting sections D decreases, and the pressure oscillation of the ink in the ejecting sections D attenuates. On the other hand, in the first embodiment, as compared with the mode in which the first potential holding component Pwh1 is a period longer than 0.25 times Tc, a timing at which the ink in the ejecting sections D is pressurized by the supply of the first pressurized-potential change component Pwc1 overlaps a timing at which the ink in the ejecting sections D is pressurized by the pressure oscillation. Therefore, according to the first embodiment, since the pressure of the ink in the ejecting sections D can be increased synergistically, the ejection speed of the ink droplets DR by the small dot ejection pulse WS may be secured.

A potential change rate of the first pressurized-potential change component Pwc1 is 4 V/μsec or more.

According to the first embodiment, the ejection speed of the ink droplets DR by the small dot ejection pulse WS may be secured, compared to a mode in which the potential change rate of the first pressurized-potential change component Pwc1 is less than 4 V/μsec.

The first depressurized-potential change component Pwd1 has a period equal to or shorter than Tc.

In a mode in which the period of the first depressurized-potential change component Pwd1 is longer than Tc, the amplitude of the pressure oscillation generated in the ink inside the ejecting sections D become excessively small, and it becomes difficult to secure the speed of the ink droplets DR after separation from the menisci MN in the first pressurized-potential change component Pwc1 after the first depressurized-potential change component Pwd1. Therefore, according to the first embodiment, it is possible to secure the speed of the ink droplets DR after the separation from the menisci MN in the first pressurized-potential change component Pwc1, when compared to a mode in which the period of the first depressurized-potential change component Pwd1 is longer than Tc.

Furthermore, the small dot ejection pulse WS further includes the second depressurized-potential change component Pwd2 that drives the drive elements 51f to reduce the ink pressure in the pressure chambers C after the first pressurized-potential change component Pwc1, the second pressurized-potential change component Pwc2 that drives the drive elements 51f to increase the ink pressure in the pressure chambers C after the second depressurized-potential change component Pwd2, the second potential holding component Pwh2 that maintains the potential from the terminal end of the second pressurized-potential change component Pwc2, and the third depressurized-potential change component Pwd3 that is connected to the terminal end of the second potential holding component Pwh2 and that drives the drive elements 51f so that the pressure of the ink in the pressure chambers C is reduced. A period Tc2d3 from the start end of the second pressurized-potential change component Pwc2 to the start end of the third depressurized-potential change component Pwd3 is 0.75 times or more of Tc.

The small dot ejection pulse WS repeats the pressurized-potential change component Pwc and the depressurized-potential change component Pwd in order to adjust weights of the ink droplets DR. According to the first embodiment, the tailings TL may be reduced as compared with a mode in which the period Tc2d3 is less than 0.75 times of Tc.

Furthermore, the period Tc1c2 from the start of the first pressurized-potential change component Pwc1 to the start of the second pressurized-potential change component Pwc2 is a period of 0.5 times or more and 0.75 times or less of Tc, and the potential change range V4 of the second pressurized-potential change component Pwc2 is 50% or more and 70% or less of the potential change range V2 of the first pressurized-potential change component Pwc1.

According to the first embodiment, when a portion of the liquid columns LC is separated from the ink in the nozzles N, it is possible to cause rear ends of the liquid columns LC to follow front end sides of the liquid columns LC without reducing the speed of the rear ends of the liquid columns LC. The tailings TL can be reduced by causing the trailing ends of the liquid columns LC to follow the tip sides of the liquid columns LC without reducing the speed of the rear ends of the liquid columns LC.

Furthermore, the period Twh2 of the second potential holding component Pwh2 is 0.5 times or more of Tc.

In the first embodiment, as compared to a mode in which the period Twh2 is less than 0.5 times Tc, the pressure fluctuation generated in the ink in the pressure chambers C due to the driving of the drive elements 51f after the second pressurized-potential change component Pwc2 may be suppressed. As described above, according to the first embodiment, the tailings TL may be reduced by suppressing the pressure oscillation of the ink.

The small dot ejection pulse WS further includes the third potential holding component Pwh3 for maintaining the potential from the terminal end of the first pressurized-potential change component Pwc1. The period Twh3 of the third potential holding component Pwh3 is a period of 0.1 times or more and 0.25 times or less of Tc. Furthermore, the potential change range V3 of the second depressurized-potential change component Pwd2 is 20% or more and 50% or less of the potential change range V2 of the first pressurized-potential change component Pwc1.

According to the first embodiment, the weights of the ink droplets DR may be adjusted to a desired amount without making the menisci MN unstable.

### 2. Modifications

Each of the above-described modes may be variously modified. Specific modification aspects that can be applied to each of the above-described modes will be described below. Any two or more aspects selected from the following examples as appropriate may be appropriately combined within a range in which they do not contradict each other.

### 2-1. First Modification

The period Tc2d3 is 0.75 times or more of Tc in the first embodiment, but may be less than 0.75 times of Tc.

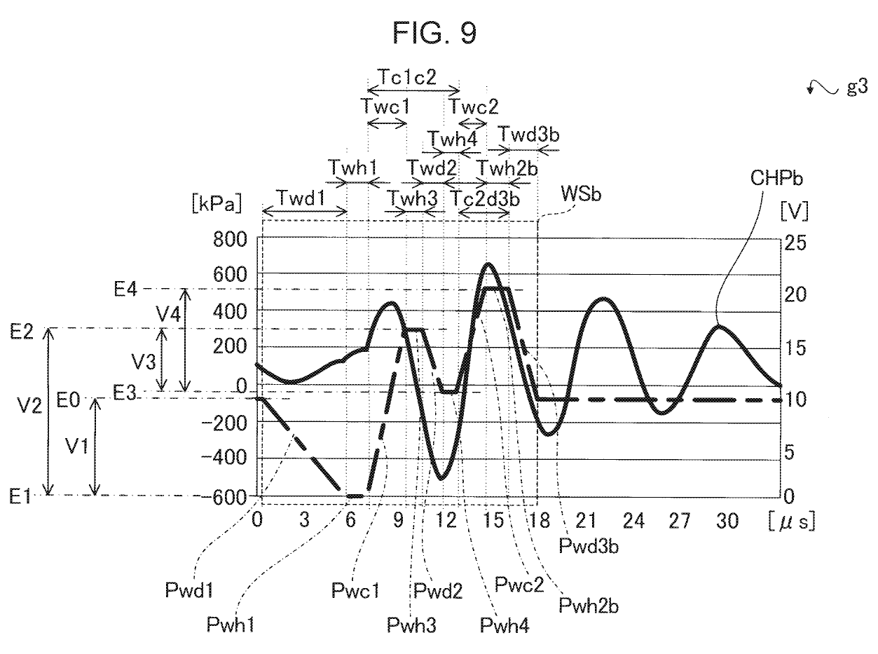

FIG. 9 is a diagram for explaining a small dot ejection pulse WSb according to a first modification. Furthermore, a graph g3 illustrated in FIG. 9 indicates a potential of the small dot ejection pulse WSb and pressure of ink in ejecting sections D. A pressure characteristic CHPb illustrated in the graph g3 indicates a characteristic of the pressure of the ink in the ejecting sections D in a case where the small dot ejection pulse WSb is supplied to the ejecting sections D.

The small dot ejection pulse WSb is different from the small dot ejection pulse WS in that the small dot ejection pulse WSb has a second potential holding component Pwh2b instead of the second potential holding component Pwh2 and has a third depressurized-potential change component Pwd3b instead of the third depressurized-potential change component Pwd3.

The second potential holding component Pwh2b is different from the second potential holding component Pwh2 in that a period Twh2b of the second potential holding component Pwh2b is a period less than 0.5 times Tc. Furthermore, the third depressurized-potential change component Pwd3b is different from the third depressurized-potential change component Pwd3 in that a potential change rate of the third depressurized-potential change component Pwd3b is 4V/μsec or more.

Even in the first modification, a potential change range V1 of a first depressurized-potential change component Pwd1 is 40% or more of a potential change range V2 of a first pressurized-potential change component Pwc1, and a potential change rate of the first depressurized-potential change component Pwd1 is 1V/μsec or more and 2V/μsec or less. Therefore, similarly to the first embodiment, since pressure chambers C are sufficiently filled with the ink before the menisci MN are protruded and amplitude of pressure oscillation generated in the ink in the ejecting sections D is not excessively increased, it is possible to secure an ejection speed of ink droplets DR after being separated from the menisci MN while reducing tailings TL.

### 2-2. Second Modification

In the first embodiment, the potential change rate of the first depressurized-potential change component Pwd1 is 1V/μsec or more and 2V/μsec or less, but is not limited thereto, and may be larger than 2V/μsec, for example.

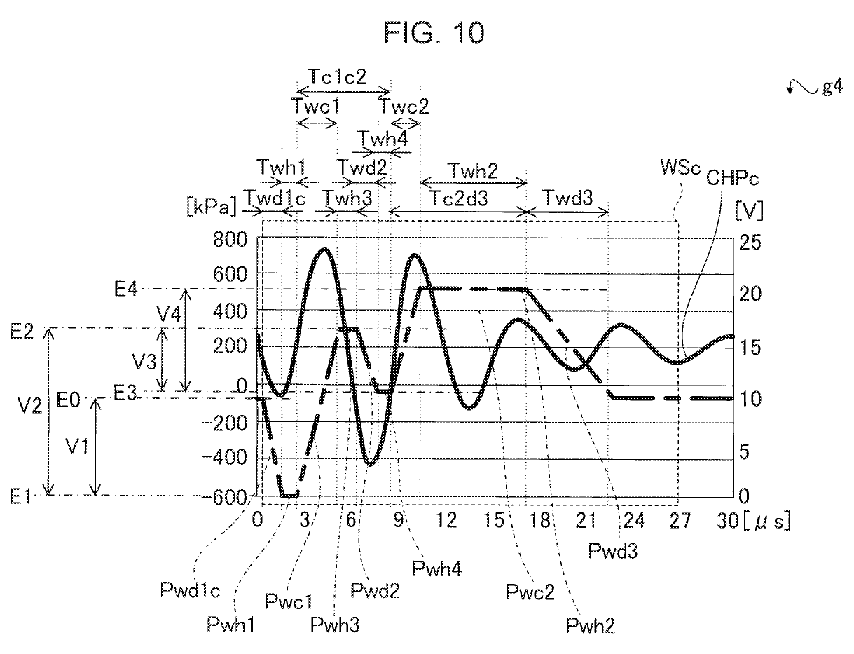

FIG. 10 is a diagram for explaining a small dot ejection pulse WSc in a second modification. Furthermore, a graph g4 illustrated in FIG. 10 indicates a potential of the small dot ejection pulse WSc and pressure of ink in ejecting sections D. A pressure characteristic CHPc illustrated in the graph g4 indicates a characteristic of the pressure of the ink in the ejecting sections D in a case where the small dot ejection pulse WSc is supplied to the ejecting sections D.

The small dot ejection pulse WSc is different from the small dot ejection pulse WS in that the small dot ejection pulse WSc has a first depressurized-potential change component Pwd1c instead of the first depressurized-potential change component Pwd1.

The first depressurized-potential change component Pwd1c is different from the first depressurized-potential change component Pwd1 in that a potential change rate of the first depressurized-potential change component Pwd1c is larger than 2V/μsec. The period Twd1c of the first depressurized-potential change component Pwd1c is equal to or shorter than Tc, but may be longer than Tc.

Even in the second modification, a period Tc2d3 from a start end of a second pressurized-potential change component Pwc2 to a start end of a third depressurized-potential change component Pwd3 is 0.75 times or more of Tc. Therefore, as in the first embodiment, tailings TL may be reduced as compared with the mode in which the period is less than 0.75 times Tc.

### 2-3. Third Modification

In the individual modes described above, the small dot ejection pulse WS is an example of the "first ejection pulse", but the large dot ejection pulse WL may be an example of the "first ejection pulse".

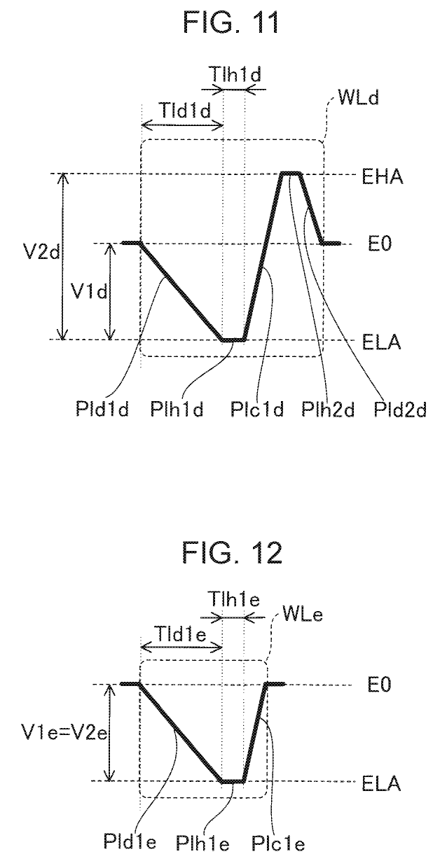

FIG. 11 is a diagram for explaining a large dot ejection pulse WLd in the third modification. The large dot ejection pulse WLd has a filling component Pld1d, a potential holding component Plh1d, an ejection component Plc1d, a vibration damping holding component Plh2d, and a vibration damping expansion component Pld2d in this order. The large dot ejection pulse WLd has a so-called pull-push-pull waveform. Note that, in the third modification, the large dot ejection pulse WLd is an example of a "first ejection pulse", the filling component Pld1d is an example of a "first depressurized-potential change component", the potential holding component Plh1d is an example of a "first potential holding component", and the ejection component Plc1d is an example of a "first pressurized-potential change component".

The potential change range V1d of the filling component Pld1d is 40% or more of a potential change range V2d of the ejection component Plc1d. Furthermore, a potential change rate of the filling component Pld1d is 1V/μsec or more and 2V/μsec or less. According to the third modification, even in the large dot ejection pulse WL, similarly to the small dot ejection pulse WS in the first embodiment, since pressure chambers C are sufficiently filled with ink before menisci MN are protruded and amplitude of pressure oscillation generated in the ink in the ejecting sections D is not excessively increased, it is possible to secure an ejection speed of ink droplets DR after being separated from the menisci MN while reducing tailings TL.

Furthermore, a period Tlh1d of the potential holding component Plh1d is not less than 0.1 times and not more than 0.25 times Tc. According to the third modification, since the pressure of the ink in the ejecting sections D can be increased synergistically, the ejection speed of the ink droplets DR by the small dot ejection pulse WS may be secured.

Moreover, a potential change rate of the ejection component Plc1d is 4V/μsec or more. According to the third modification, the ejection speed of the ink droplets DR by the large dot ejection pulse WLd may be secured, compared to a mode in which the potential change rate of the ejection component Plc1d is less than 4V/μsec.

Furthermore, a period Tld1d of the filling component Pld1d is equal to or less than TC. According to the third modification, it is possible to secure the speed of the ink droplets DR after the separation from the menisci MN in the first presssurized-potential change component Pwc1, when compared to the mode in which the period of the first depressurized-potential change component Pwd1 is longer than Tc.

### 2-4. Fourth Modification

In the third modification, the large dot ejection pulse WLd having the pull-push-pull waveform is an example of the "first ejection pulse", but the present disclosure is not limited thereto. For example, a so-called pull-push waveform may be an example of the "first ejection pulse".

FIG. 12 is a diagram for explaining a large dot ejection pulse WLe in the fourth modification. The large dot ejection pulse WLe includes a filling component Pld1e, a potential holding component Plh1e, and an ejection component Plc1e in this order. The large dot ejection pulse WLe has a so-called pull-push waveform. Note that, in the fourth modification, the large dot ejection pulse WLe is an example of the "first ejection pulse", the filling component Pld1e is an example of the "first depressurized-potential change component", the potential holding component Plh1e is an example of the "first potential holding component", and the ejection component Plc1e is an example of a "first pressurized-potential change component".

A potential change range V1e of the filling component Pld1e is substantially the same as a potential change range V2e of the ejection component Plc1e. Therefore, the fourth modification also satisfies the condition that the potential change range V1e is 40% or more of the potential change range V2e. That is, the potential change range V1e may be equal to or larger than the potential change range V2e.

A potential change rate of the filling component Pld1e is 1V/μsec or more and 2V/μsec or less. A period Tlh1e of the potential holding component Plh1e is not less than 0.1 times and not more than 0.25 times Tc. A potential change rate of the ejection component Plc1e is 4V/μsec or more. A period Tld1e of the filling component Pld1e is equal to or less than Tc.

### 2-5. Fifth Modification

In the fourth modification, the large dot ejection pulse WLe having the pull-push waveform is an example of the "first ejection pulse", but the present disclosure is not limited thereto. For example, a so-called pull-push-push waveform may be an example of the "first ejection pulse".

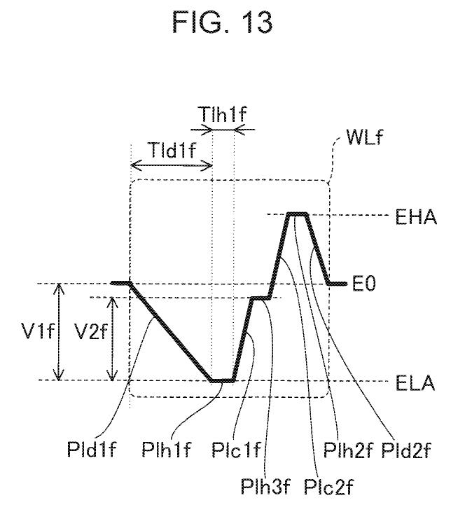

FIG. 13 is a diagram for explaining a large dot ejection pulse WLf in a fifth modification. The large dot ejection pulse WLf has a filling component Pld1f, a potential holding component Plh1f, an ejection component Plc1f, a potential holding component Plh3f, an ejection component Plc2f, a vibration damping holding component Plh2f, and a vibration damping expansion component Pld2f in this order. The large dot ejection pulse WLf is a so-called pull-push-push waveform. Note that, in the fifth modification, the large dot ejection pulse WLf is an example of the "first ejection pulse", the filling component Pld1f is an example of the "first depressurized-potential change component", the potential holding component Plh1f is an example of the "first potential holding component", and the ejection component Plc1f is an example of a "first pressurized-potential change component".

A potential change range V1f of the filling component Pld1f is larger than a potential change range V2f of the ejection component Plc1f. Therefore, the fifth modification also satisfies the condition that the potential change range V1f is 40% or more of the potential change range V2f.

A potential change rate of the filling component Pld1f is 1V/μsec or more and 2V/μsec or less. A period Tlh1f of the potential holding component Plh1f is not less than 0.1 times and not more than 0.25 times Tc. A potential change rate of the ejection component Plc1f is 4V/μsec or more. A period Tld1f of the filling component Pld1f is equal to or less than Tc.

### 2-6. Sixth Modification

The period Twh1 of the first potential holding component Pwh1 is not less than 0.1 times and not more than 0.25 times Tc in the first embodiment, the first modification, and the second modification, but is not limited thereto. For example, the period Twh1 may be less than 0.1 times or more than 0.25 times as long as Tc. Similarly, in the third modification to the fifth modification, the period Tlh1d of the potential holding component Plh1 may be less than 0.1 times Tc, or may be longer than 0.25 times Tc.

### 2-7. Seventh Modification

The potential change rate of the first pressurized-potential change component Pwc1 is 4V/μsec or more in the first embodiment, the first modification, the second modification, and the sixth modification based on one aspect of the first embodiment, the first modification, and the second modification, but is not limited thereto. For example, the potential change rate of the first pressurized-potential change component Pwc1 may be less than4 V/μsec. Similarly, in the third to fifth modifications and a sixth modification based on one aspect of the third to fifth modifications, a potential change rate of the ejection component Plc1 may be less than 4V/μsec.

### 2-8. Eighth Modification

The first depressurized-potential change component Pwd1 is a period of Tc or less in the first embodiment, the first modification, the second modification, and the sixth modification or the seventh modification based on one aspect of the first embodiment, the first modification, and the second modification, but is not limited thereto. The first depressurized-potential change component Pwd1 may be a period longer than Tc. Similarly, in the third to fifth modifications and the sixth or seventh modification based on one aspect of the third to fifth modifications, the filling component Pld1 may be a period longer than Tc.

### 2-9. Ninth Modification

The period Tc1c2 from the start of the first pressurized-potential change component Pwc1 to the start of the second pressurized-potential change component Pwc2 is a period of 0.5 times or more and 0.75 times or less of Tc in the first embodiment, the first modification, the second modification, and the sixth modification to the eighth modification based on one aspect of the first embodiment, the first modification, and the second modification, but may be less than 0.5 times or more than 0.75 times of Tc. Alternatively, the potential change range V4 of the second pressurized-potential change component Pwc2 may be less than 50% or more than 70% of the potential change range V2 of the first pressurized-potential change component Pwc1.

### 2-10. Tenth Modification

The period Twh2 of the second potential holding component Pwh2 is 0.5 times or more of Tc in the first embodiment, the first modification, the second modification, and the sixth modification to the ninth modification based on one aspect of the first embodiment, the first modification, and the second modification, but may be less than 0.5 times.

### 2-11. Eleventh Modification

The period Twh3 of the third potential holding component Pwh3 is a period of 0.1 times or more and 0.25 times or less of Tc and the potential change range V3 of the second depressurized-potential change component Pwd2 is 20% or more and 50% or less of the potential change range V2 of the first pressurized-potential change component Pwc1 in the first embodiment, the first modification, the second modification, and the sixth modification to the tenth modification based on one aspect of the first embodiment, the first modification, and the second modification, but the present disclosure is not limited thereto. For example, the period Twh3 may be less than 0.1 times Tc or may be longer than 0.25 times Tc. Furthermore, the potential change range V3 may be less than 20% or more than 50% of the potential change range V2.

### 2-12. Twelfth Modification

In the individual modes described above, the method for manufacturing the serial type liquid ejecting apparatus 100 in which the liquid ejecting head 50 reciprocates in the direction along the X-axis has been exemplified, but the present disclosure is not limited to these modes. The liquid ejecting apparatus 100 may be a line-type liquid ejecting apparatus in which the plurality of nozzles N are distributed over an entire width of the medium PP.

### 2-13. Other Modifications

The above-described liquid ejecting apparatus 100 may be employed in various apparatuses, such as a facsimile apparatus and a copy machine, in addition to an apparatus dedicated to printing. However, the use of the recording apparatus of the present disclosure is not limited to printing. For example, a recording apparatus that ejects solution of coloring material is used as a manufacturing apparatus that forms a color filter of a liquid crystal display device. In addition, a recording apparatus which ejects solution of conductive material is used as a manufacturing apparatus which forms wiring and electrodes of a wiring substrate.

What is claimed is:

1. A liquid ejecting apparatus comprising:
an ejecting section that includes a nozzle which ejects a liquid, a pressure chamber which communicates with the nozzle, and a drive element which is driven so as to generate pressure fluctuation in the liquid in the pressure chamber in response to a supplied drive signal; and
a drive signal generation circuit that is configured to generate the drive signal, wherein
the drive signal includes a first ejection pulse for ejecting the liquid from the nozzle,
the first ejection pulse includes
a first depressurized-potential change component that drives the drive element so that pressure of the liquid in the pressure chamber is reduced, and
a first pressurized-potential change component that drives the drive element so that the pressure of the liquid in the pressure chamber increases such that liquid surfaces protrude from the nozzles after the first depressurized-potential change component,
a potential change range of the first depressurized-potential change component is 40% or more of a potential change range of the first pressurized-potential change component, and
a potential change rate of the first depressurized-potential change component is 1 V/μsec or more and 2 V/μsec or less.

2. The liquid ejecting apparatus according to claim 1, wherein
the first ejection pulse further includes
a first potential holding component that connects a terminal end of the first depressurized-potential change component and a start end of the first pressurized-potential change component and maintains a predetermined potential,
the first potential holding component has a period of 0.1 times or more and 0.25 times or less of a natural period, and
the natural period is a natural period in the ejecting sections.

3. The liquid ejecting apparatus according to claim 1, wherein
a potential change rate of the first pressurized-potential change component is equal to or greater than 4 V/μsec.

4. The liquid ejecting apparatus according to claim 1, wherein
the first depressurized-potential change component has a period equal to or less than a natural period, and
the natural period is a natural period in the ejecting section.

5. The liquid ejecting apparatus according to claim 1, wherein
the first ejection pulse further includes
a second depressurized-potential change component that drives the drive element so as to reduce pressure of liquid in the pressure chamber after the first pressurized-potential change component,
a second pressurized-potential change component that drives the drive element so that the pressure of the liquid in the pressure chamber increases after the second depressurized-potential change component,
a second potential holding component that maintains a potential from a terminal end of the second pressurized-potential change component, and
a third depressurized-potential change component that is connected to a terminal end of the second potential holding component and drives the drive element so as to reduce the pressure of the liquid in the pressure chamber,
a period from a start end of the second pressurized-potential change component to a start end of the third depressurized-potential change component is 0.75 times or more of a natural period, and
the natural period is a natural period in the ejecting section.

6. The liquid ejecting apparatus according to claim 5, wherein
a period from a start of the first pressurized-potential change component to a start of the second pressurized-potential change component is a period of 0.5 times or more and 0.75 times or less of the natural period, and
a potential change range of the second pressurized-potential change component is 50% or more and 70% or less of a potential change range of the first pressurized-potential change component.

7. The liquid ejecting apparatus according to claim 5, wherein
a period of the second potential holding component is 0.5 times or more of the natural period.

8. The liquid ejecting apparatus according to claim 5, wherein
the first ejection pulse further includes
a third potential holding component that maintains a potential from a terminal end of the first pressurized-potential change component, and
a period of the third potential holding component is a period of 0.1 times or more and 0.25 times or less of the natural period, and
a potential change range of the second depressurized-potential change component is 20% or more and 50% or less of a potential change range of the first pressurized-potential change component.

9. A driving method for driving a liquid ejecting apparatus including an ejecting section that includes a nozzle which ejects a liquid, a pressure chamber which communicates with the nozzle, and a drive element which is driven so as to generate pressure fluctuation in the liquid in the pressure chamber in response to a supplied drive signal and a drive signal generation circuit that is configured to generate the drive signal, wherein
the drive signal includes a first ejection pulse for ejecting the liquid from the nozzle,
the first ejection pulse includes
a first depressurized-potential change component that drives the drive element so that pressure of the liquid in the pressure chamber is reduced, and
a first pressurized-potential change component that drives the drive element so that pressure of the liquid in the pressure chamber increases such that liquid surfaces protrude from the nozzles after the first depressurized-potential change component,
a potential change range of the first depressurized-potential change component is 40% or more of a potential change range of the first pressurized-potential change component,
a potential change rate of the first depressurized-potential change component is 1 V/μsec or more and 2 V/μsec or less, and
the driving method including:
supplying the first depressurized-potential change component to the drive element of the ejecting section, and
supplying the first pressurized-potential change component to the drive element of the ejecting section.
